(19) United States
(12) Patent Application Publication
(10) Pub. No.: US 2026/0254257 A1
(43) Pub. Date: Aug. 27, 2026

(54) POWER SUPPLY SYSTEM AND OFFICE INTEGRATED POWER SUPPLY DEVICE

(71) Applicant: Anker Innovations Technology Co., Ltd., CHANGSHA (CN)

(72) Inventors: Xincan TIAN, SHENZHEN (CN); Wei XIE, SHENZHEN (CN); Bo ZHAO, SHENZHEN (CN)

(21) Appl. No.: 19/534,117

(22) Filed: Feb. 9, 2026

(30) Foreign Application Priority Data
Feb. 27, 2025 (CN) 202520337887.7

(51) Int. Cl. H02J 4/25

(52) U.S. Cl. CPC H02J 4/25

(57) ABSTRACT

The application provides a power supply system and an office integrated power supply device. In the power supply system, a first end of a first conversion block is connected to a power grid, and the first conversion block is configured to convert a first alternating current voltage of the power grid into a first direct current voltage; at least one first power module and at least one second power module are connected to a second end of the first conversion block; each first power module is configured to convert the first direct current voltage into a second direct current voltage, so as to supply power to a first external device; each second power module is configured to convert the first direct current voltage into a second alternating current voltage, so as to supply power to a second external device.

### CROSS REFERENCE TO RELATED APPLICATIONS

The present disclosure claims priority to Chinese Patent Application No. 202520337887.7, filed on February 27, 2025, the entire contents of which are incorporated herein by reference.

### TECHNICAL FIELD

The present disclosure relates to the technical field of power supply, and in particular to a power supply system and an office integrated power supply device.

### BACKGROUND

In the related art, in an office integrated power supply system, a power grid typically distributes alternating current to different office workstations through a power distribution cabinet. Each office workstation is provided with an alternating current-direct current (AC-DC) power block configured to convert the alternating current into low-voltage direct current for charging an intelligent device such as a mobile phone, a tablet, and a computer at the office workstation. Meanwhile, each office workstation is also provided with a power strip for direct alternating current supply to power devices requiring alternating current input.

In a case where there are a large number of workstations in an office area and each workstation requires to be provided with one AC-DC power block, the standby power consumption of multiple AC-DC power blocks over a long period is substantial, resulting in significant energy waste. In addition, an excessive number of power strips with high-voltage alternating current output may age over time, which is prone to causing fires and poses low safety.

### SUMMARY

Embodiments of the present disclosure may provide a power supply system including a first conversion block, at least one first power module, and at least one second power module.

A first end of the first conversion block may be connected to the power grid, and the first conversion block may be configured to convert a first alternating current voltage of the power grid into a first direct current voltage.

The at least one first power module may be connected to a second end of the first conversion block, each of the at least one first power module may be configured to convert the first direct current voltage into a second direct current voltage, and the second direct current voltage may be configured to supply power to a first external device.

The at least one second power module may be connected to the second end of the first conversion block, each of the at least one second power module may be configured to convert the first direct current voltage into a second alternating current voltage, and the second alternating current voltage may be configured to supply power to a second external device.

Embodiments of the present disclosure may also provide an office integrated power supply device including at least one office workstation and the power supply system as described above. The first power module and the second power module of the power supply system may be disposed at a corresponding one of the at least one office workstation and may be configured to supply power to external devices located at the corresponding one of the at least one office workstation.

### BRIEF DESCRIPTION OF THE DRAWINGS

In order to more clearly illustrate the technical solutions in the embodiments of the present disclosure, the drawings required for describing the embodiments may be briefly introduced below. Obviously, the drawings in the following description may be some embodiments of the present disclosure. For those of ordinary skill in the art, other drawings may also be obtained according to these drawings without creative work.

FIG. 1 is a schematic structure view of a power supply system according to a first embodiment of the present disclosure.

FIG. 2 is a schematic structure view of a power supply system according to a second embodiment of the present disclosure.

FIG. 3 is a schematic structure view of a power supply system according to a third embodiment of the present disclosure.

FIG. 4 is a schematic structure view of a power supply system according to a fourth embodiment of the present disclosure.

FIG. 5 is a schematic structure view of a power supply system according to a fifth embodiment of the present disclosure.

FIG. 6 is a schematic structure view of an office integrated power supply device according to some embodiments of the present disclosure.

### DETAILED DESCRIPTION

The solutions of the embodiments of the present disclosure may be described in detail below in conjunction with the accompanying drawings of the specification.

In the following description, for the purpose of illustration rather than limitation, specific details such as specific system structures, interfaces, and technologies may be proposed to thoroughly understand the present disclosure.

Reference to the term "embodiment" in the present disclosure may mean that a specific feature, structure, or characteristic described in conjunction with the embodiment may be included in at least one embodiment of the present disclosure. The appearance of the phrase at various positions in the specification may not necessarily refer to the same embodiment, nor is it an independent or alternative embodiment mutually exclusive with other embodiments. It is explicitly and implicitly understood by those skilled in the art that the embodiments described herein may be combined with other embodiments.

In the present disclosure, the term "and/or" may only be a kind of associative relationship for describing associated objects, indicating that there are three possible relationships. For example, A and/or B may indicate the following three situations: A exists alone, A and B exist simultaneously, and B exists alone. In addition, the character "/" in the description may generally indicate that associated objects preceding and following the character are in an "or" relationship. In addition, the term "plurality" in the description may mean two or more. In addition, the term "at least one" in the description may indicate any one of a plurality of items or any combination of at least two of a plurality of items. For example, including at least one of A, B, and C may indicate selecting any one or more elements from a set composed of A, B, and C. In addition, the terms "first", "second", and "third" in the present disclosure may only be used for descriptive purposes, and shall not be understood as indicating or implying relative importance, nor as implicitly indicating the number of technical features denoted thereby.

A conventional office integrated direct current power supply system may typically distribute high-voltage power from the electrical grid to each office area through an alternating current power distribution cabinet. Each area may be equipped with an air switch for safety protection, after which the high-voltage power may be split into two circuits. A first circuit may pass through an AC-DC power block to convert the high-voltage alternating current into low-voltage direct current, and may be equipped with a Type-C interface or a USB-A interface to supply power to an intelligent device such as a mobile phone, a tablet, and a computer. A second circuit may be directly connected to a power strip after passing through a secondary air switch, and the power strip may be installed directly at an office workstation to power an electrical device requiring alternating current supply.

The conventional office integrated direct current power supply system may have problems as follows. 1. The Type-C interface and the USB-A interface may only supply power to the intelligent device such as the mobile phone, the tablet, and the computer, and may not charge a device without a charging protocol, which is not friendly to various charging scenarios. 2. In a case where the AC-DC block is damaged, professional maintenance personnel may be required for repairs, resulting in high maintenance difficulty. 3. Since only one air switch is equipped in one office area, in a case where there is a circuit abnormality at one office workstation, the entire office area may need to be powered off for maintenance, which is not friendly to the personnel in the office area. 4. High-voltage alternating current output may cause the circuit to be prone to aging and damage, leading to fires, and thus poses low safety. 5. Each office workstation may need to be equipped with an AC-DC power block. In a case where there are many office workstations, the energy consumption is substantial, resulting in significant energy waste.

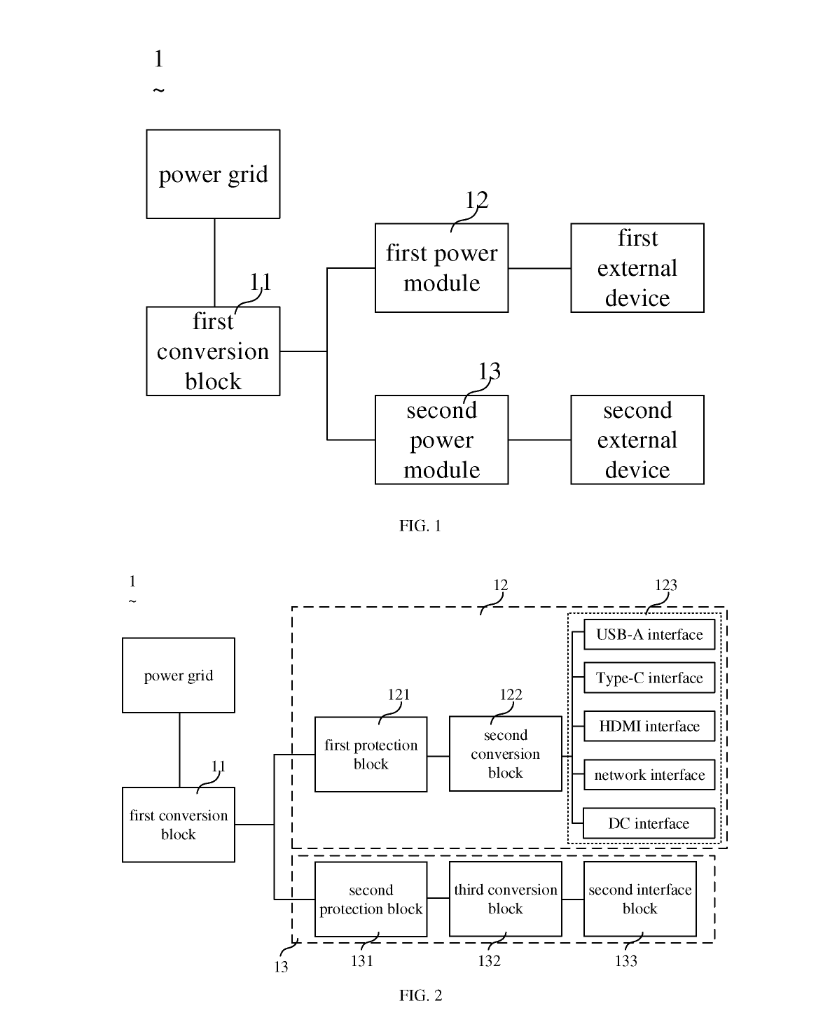

Based on the problems mentioned above, the embodiments of the present disclosure may provide a power supply system configured to supply power to various electrical devices, reduce energy consumption, lower maintenance difficulty, and improve user safety during use. As shown in FIG. 1, FIG. 1 is a schematic structure view of a power supply system according to a first embodiment of the present disclosure. The power supply system 1 provided by the embodiments of the present disclosure may include a first conversion block 11, at least one first power module 12, and at least one second power module 13.

A first end of the first conversion block 11 may be connected to a power grid. The first conversion block 11 may be configured to convert a first alternating current voltage of the power grid into a first direct current voltage. The first conversion block 11 may be an AC-DC block. The power grid may distribute alternating current to the first conversion block 11 through an alternating current power distribution cabinet. The first conversion block 11 may convert the alternating current into direct current to supply the direct current to the first power module 12 and the second power module 13.

In practical applications, alternating current may be affected by factors such as electromagnetic induction, resistance, and capacitance during transmission, resulting in a certain amount of energy loss. Particularly during long-distance power transmission, the loss of alternating current power transmission may increase significantly. Therefore, the transmission efficiency of alternating current may be lower than the transmission efficiency of direct current. In the embodiments, the first conversion block 11 may first convert the first alternating current voltage into the first direct current voltage, which may effectively improve voltage transmission efficiency and reduce energy consumption. Meanwhile, by converting the first alternating current voltage into the first direct current voltage for transmission, i.e., converting high-voltage alternating current into low-voltage direct current, all areas accessible to users may be supplied with low-voltage direct current. This may reduce the risk of electric shock to users, improve user safety during use, and enhance the safety of the power supply system 1.

The first power module 12 may be connected to a second end of the first conversion block 11, and may be configured to convert the first direct current voltage into a second direct current voltage. The second direct current voltage may be configured to supply power to a first external device. The first power module 12 may be a direct current power module. After receiving the first direct current voltage, the first power module 12 may adjust a voltage value of the first direct current voltage, either increasing or decreasing the voltage value of the first direct current voltage, to obtain the second direct current voltage. The first power module 12 may output the second direct current voltage to supply power to the first external device.

It may be understood that the voltage value of the first direct current voltage may be different from a voltage value of the second direct current voltage. The first external device may be an electrical device requiring direct current power supply.

The second power module 13 may be connected to the second end of the first conversion block 11, and may be configured to convert the first direct current voltage into a second alternating current voltage. The second alternating current voltage may be configured to supply power to a second external device. The second external device may be an electrical device requiring alternating current power supply. By arranging the second power module 13 to convert the first direct current voltage into the second alternating current voltage to supply power to the second external device, the power supply system 1 may supply power to both the first external device requiring direct current power supply and the second external device requiring alternating current power supply, which may improve the practicability of the power supply system 1.

In summary, by arranging the first conversion block 11 to convert the first alternating current voltage of an external power supply (i.e., the power grid) into the first direct current voltage for transmission, the energy consumption in the power supply system 1 may be reduced, and all areas accessible to users may be supplied with low-voltage direct current, which may enhance the safety of the power supply system 1.

The power supply system 1 may include the first conversion block 11, the at least one first power module 12, and the at least one second power module 13, so that the power supply system 1 may supply power to the first external device and the second external device. In a case where the user needs to use both the first external device and the second external device for work, the power supply system 1 may be provided with both the first power module 12 and the second power module 13 to supply power to external devices. This configuration may meet the power supply requirements of the external devices, improve the practicability of the power supply system 1, and enhance the user experience with the power supply system 1.

In some embodiments, the power supply system 1 may only include the first conversion block 11 and the at least one first power module 12. The power supply system 1 may supply power to the first external device. Since the power supply system 1 is not provided with the second power module 13, the number of components in the power supply system 1 may be reduced, thereby lowering both energy consumption and component costs. Meanwhile, the number of high-voltage alternating current output ports (an output of the second power module 13 is the second alternating current voltage, such that an output port of the second power module 13 may be a high-voltage alternating current output port) may be reduced, improving user safety when the power supply system 1 is used to supply power to the external device.

In some embodiments, the power supply system 1 may only include the first conversion block 11 and the at least one second power module 13, so the power supply system 1 may supply power to the second external device. Since the power supply system 1 is not provided with the first power module 12, the number of components in the power supply system 1 may be reduced, thereby lowering energy consumption.

It may be understood that in practical applications, the user may arrange the number of the first power module 12 and the second power module 13 in the power supply system 1 according to requirements, which is not limited in the present disclosure.

As shown in FIG. 2, FIG. 2 is a schematic structure view of a power supply system according to a second embodiment of the present disclosure. The first power module 12 may include a first protection block 121, a second conversion block 122, and a first interface block 123.

The second conversion block 122 may be detachably disposed between the first protection block 121 and the first interface block 123. A first end of the second conversion block 122 may be connected to the second end of the first conversion block 11 through the first protection block 121. A second end of the second conversion block 122 may be connected to the first interface block 123. The second conversion block 122 may be configured to convert the first direct current voltage into the second direct current voltage. The first interface block 123 may be connected to the first external device.

The second conversion block 122 may be a direct current-direct current (DC-DC) block, which may convert a direct current voltage into another direct current voltage. The second conversion block 122 may be configured to convert the first direct current voltage into a second direct current voltage with a higher voltage value or a second direct current voltage with a lower voltage value, which may be determined by a power supply voltage required by the first external device. Since the first interface block 123 is connected to the second end of the second conversion block 122, and the first external device is connected to the first interface block 123, the second conversion block 122 may output the second direct current voltage to the first external device via the first interface block 123, so as to supply power to the first external device.

It may be understood that a relative relationship between the voltage value of the first direct current voltage and the voltage value of the second direct current voltage may be determined by the power supply voltage required by the first external device, which is not limited in the present disclosure.

In some embodiments, the first protection block 121 may be a hot-swappable power supply protection block. The hot-swappable function may allow the user to remove or replace a damaged component such as a hard disk, a power supply, or a board without shutting down the system or cutting off power, thereby improving the system's ability to recover from disasters in a timely manner, and scalability and flexibility of the system. In the embodiments, the first protection block 121 may be disposed before the second conversion block 122 to enable a detachable connection of the second conversion block 122. Furthermore, in a case where the second conversion block 122 is abnormal or damaged, the user may replace the second conversion block 122 without professional personnel, which may reduce the maintenance difficulty of the first power module 12. In addition, the second conversion block 122 may be replaced with power on, which may not affect circuits in other areas and thus enhance the user experience with the power supply system 1.

The first interface block 123 may include at least one of a Type-C interface, a USB-A interface, an HDMI interface, a network interface, and a DC interface. The Type-C interface and the USB-A interface may be connected to an intelligent device such as a mobile phone, a tablet, and a computer. The HDMI interface may be connected to an extended display screen, etc. The network interface may be connected to a network device. The DC interface may be connected to an electric tool, etc. Therefore, the second conversion block 122 may supply power to a connected first external device via a corresponding interface. This configuration may improve the compatibility of the power supply system 1, enable the power supply system 1 to support a diverse range of powered devices, enhance the practicability of the power supply system 1, and boost the user experience with the power supply system 1.

The DC interface may be customized based on an interface type required by the electric tool, so as to meet the power supply requirements of devices with different interfaces.

In some embodiments, the first interface block 123 may also include other types of interfaces. The types of interfaces included in the first interface block 123 and/or the quantity of a specific interface type may be configured according to user requirements, which is not limited in the present disclosure.

The second power module 13 may include a second protection block 131, a third conversion block 132, and a second interface block 133.

The third conversion block 132 may be detachably disposed between the second protection block 131 and the second interface block 133. A first end of the third conversion block 132 may be connected to the second end of the first conversion block 11 via the second protection block 131. A second end of the third conversion block 132 may be connected to the second interface block 133. The third conversion block 132 may be configured to convert the first direct current voltage into the second alternating current voltage. The second interface block 133 may be connected to the second external device.

The third conversion block 132 may be a direct current-alternating current (DC-AC) block, which may convert the first direct current voltage into the second alternating current voltage. The second interface block 133 may be connected to the second end of the third conversion block 132, and the second external device may be connected to the second interface block 133. The third conversion block 132 may transmit the second alternating current voltage to the second external device via the second interface block 133, so as to supply power to the second external device. This configuration may improve the practicability of the power supply system 1. It may be understood that a voltage value of the first alternating current voltage may be equal to or different from a voltage value of the second alternating current voltage, which is not limited in the present disclosure.

In some embodiments, the second interface block 133 may include a power strip, a socket, or other devices. The second protection block 131 may be a hot-swappable power supply protection block the same as the first protection block 121, which may enable a detachable connection of the third conversion block 132 between the second protection block 131 and the second interface block 133. Furthermore, in a case where the third conversion block 132 is abnormal or damaged, the user may replace the third conversion block 132 by himself, which may reduce the maintenance difficulty and improve the practicability of the power supply system 1.

In summary, in the embodiments, the first power module 12 may include the first protection block 121, the second conversion block 122, and the first interface block 123. The second conversion block 122 may be configured to convert the first direct current voltage into the second direct current voltage, and then the second conversion block 122 may transmit the second direct current voltage to the first external device via the first interface block 123, thereby enabling the power supply system 1 to supply power to the first external device. The first protection block 121 may be configured to protect a circuit of the first power module 12 and to enable the detachable connection of the second conversion block 122 between the first protection block 121 and the first interface block 123. This configuration may reduce the maintenance difficulty of the power supply system 1 and improve the user experience with the power supply system 1. In addition, the first interface block 123 may include various types of interfaces, thereby enabling connection to various types of first external devices, enabling the power supply system 1 to supply power to various types of first external devices, and further enhancing the practicability of the power supply system 1.

The second power module 13 may include the second protection block 131, the third conversion block 132, and the second interface block 133. The third conversion block 132 may be configured to convert the first direct current voltage into the second alternating current voltage, and then the third conversion block 132 may transmit the second alternating current voltage to the second external device via the second interface block 133, thereby enabling the power supply system 1 to supply power to the second external device. The second protection block 131 may be configured to protect a circuit of the second power module 13 and to enable the detachable connection of the third conversion block 132 between the second protection block 131 and the second interface block 133. This configuration may reduce the maintenance difficulty of the power supply system 1 and improve the user experience with the power supply system 1.

In practical applications, direct current may show significant advantages in terms of conversion efficiency. During a direct current conversion process, since direct current does not require frequency or phase conversion, the conversion process may be relatively simple and efficient. However, alternating current may undergo multiple voltage and frequency conversions during power generation, transmission, and utilization, and these conversion processes may result in certain energy losses. Therefore, the conversion efficiency of converting alternating current into direct current may be lower than the conversion efficiency of converting direct current into direct current, and may be also lower than the conversion efficiency of converting direct current into alternating current. In the embodiments, the power supply system 1 may achieve voltage conversion by first arranging the first conversion block 11 to convert the first alternating current voltage into the first direct current voltage, then arranging the first power module 12 to convert the first direct current voltage into the second direct current voltage to supply power to the first external device, and arranging the second power module 13 to convert the first direct current voltage into the second alternating current voltage to supply power to the second external device. Compared with the related art that requires multiple AC-DC blocks to convert alternating current into direct current, the power supply system 1 provided by the present disclosure may achieve a significant improvement in voltage conversion efficiency, along with higher overall conversion efficiency in the power supply system 1 and effective reduction in energy consumption in the power supply system 1.

In some embodiments, the second conversion block 122 may be detachably connected between the first protection block 121 and the first interface block 123, the third conversion block 132 may be detachably connected between the second protection block 131 and the second interface block 133, and the power supply system 1 may be provided with both the first power module 12 and the second power module 13. In a case where the user does not need to power the second external device for work or the number of first external devices requiring power supply increases, the user may replace the third conversion block 132 in the second power module 13 with a second conversion block 122. This replacement may increase the number of first power modules 12 in the power supply system 1, may provide more interfaces for the first external devices, may allow the user to power more first external devices, and thus may improve the user experience with the power supply system 1. It should be understood that the user may also replace the second conversion block 122 in the first power module 12 with a third conversion block 132 according to requirements, which is not limited in the present disclosure.

The second conversion block 122 and the third conversion block 132 may be blocks of the same size.

In some embodiments, as described above, the power supply system 1 may be provided with only the first power module 12. In a case where the power supply system 1 is provided with only the first power module 12 to supply power to the first external device, but the user subsequently may need to use the second external device for work and thus may require the power supply system 1 to supply power to the second external device, the user may not need to replace the entire power supply system 1 or move to another area where the second power module 13 is provided for work. Instead, the user may only need to replace the second conversion block 122 in the first power module 12 with a third conversion block 132 to output the second alternating current voltage and supply power to the second external device. This configuration may improve the practicability of the power supply system 1 and enhance the user experience with the power supply system 1.

In some embodiments, as described above, the power supply system 1 may be provided with only the second power module 13. In a case where the power supply system 1 is provided with only the second power module 13, but the user subsequently may need to use the first external device for work and thus may require the power supply system 1 to supply power to the first external device, the user may replace the third conversion block 132 in the second power module 13 with a second conversion block 122 to output the second direct current voltage to supply power to the first external device.

As shown in FIG. 3, FIG. 3 is a schematic structure view of a power supply system according to a third embodiment of the present disclosure. The power supply system 1 provided by the embodiments may further include a protection switch 14 and a connection block 15.

A first end of the protection switch 14 may be connected to the external power supply. A second end of the protection switch 14 may be connected to a first end of the connection block 15. A second end of the connection block 15 may be connected to the first power module 12 and the second power module 13. The first conversion block 11 may be detachably installed on the connection block 15. The first end of the connection block 15 and the second end of the connection block 15 may be connected via the first conversion block 11.

The protection switch 14 may be the air switch mentioned above to protect circuits of the power supply system 1. The connection block 15 may be a power strip. In a case where the first conversion block 11 is not installed on the connection block 15, the first end of the connection block 15 and the second end of the connection block 15 may not be connected, so the external power supply may be disconnected from the first power module 12 and the second power module 13. After the first conversion block 11 is installed on the connection block 15, the first end of the connection block 15 and the second end of the connection block 15 may be connected via the first conversion block 11. That is, the first alternating current voltage of the external power supply may enter the first conversion block 11 via the first end of the connection block 15. After the first alternating current voltage is converted into the first direct current voltage, the first conversion block 11 may transmit the first direct current voltage to the first power module 12 and the second power module 13 via the second end of the connection block 15.

The first conversion block 11 may be detachably installed on the connection block 15. In a case where the first conversion block 11 is abnormal or damaged, the user may replace the first conversion block 11 without the need for maintenance personnel, thereby further reducing the maintenance difficulty of the power supply system 1.

A plurality of first conversion blocks 11 may be disposed on the connection block 15, and each first conversion block 11 may provide the first direct current voltage for the first power module 12 and the second power module 13.

For example, an output power of the first conversion block 11 may be 1000 W, an output power of the second conversion block 122 in the first power module 12 may be 200 W, and an output power of the third conversion block 132 in the second power module 13 may be 300 W. One first conversion block 11 may provide the first direct current voltage for 2 first power modules 12 and 2 second power modules 13. Alternatively, one first conversion block 11 may transmit the first direct current voltage to 5 first power modules 12. Alternatively, one first conversion block 11 may transmit the first direct current voltage to 3 second power modules 13.

In a case where the power supply system 1 includes 10 first power modules 12 and 10 second power modules 13, 5 first conversion blocks 11 may be disposed on the connection block 15 to supply power to 20 power modules ((i.e., the 10 first power modules 12 and 10 second power modules 13). Compared with the related art that requires a greater number of AC-DC blocks, the number of first conversion blocks 11 in the present disclosure may be significantly reduced, thereby effectively lowering the energy consumption of the power supply system 1.

In some embodiments, the output power of the first conversion block 11, the output power of the second conversion block 122, and the output power of the third conversion block 132 may be set to other values. These values may be freely matched based on an actual value of output power of each conversion block, and may not be limited in the present disclosure.

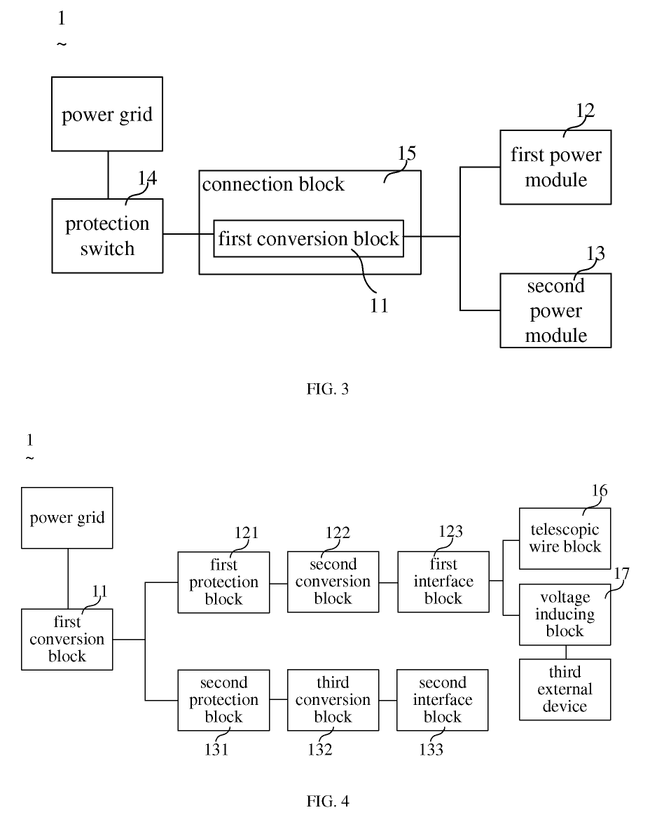

As shown in FIG. 4, FIG. 4 is a schematic structure view of a power supply system according to a fourth embodiment of the present disclosure. The power supply system 1 provided by the embodiments of the present disclosure may further include a telescopic wire block 16. The telescopic wire block 16 may be detachably connected to the first interface block 123. The first interface block 123 may supply power to the first external device via the telescopic wire block 16.

The telescopic wire block 16 may be a block configured to stretch and retract a data wire by means of a clockwork spring. In a case where the first external device is located far from the first interface block 123, the user may use the telescopic wire block 16 to connect the first interface block 123 to the first external device, allowing the first interface block 123 to supply power to the first external device via the telescopic wire block 16. This may enable flexible installation positions for the first power module 12. The installation position of the first power module 12 may thus not be limited by an installation position of the first external device, which may improve the user experience with the power supply system 1.

The power supply system 1 may further include a voltage inducing block 17. The voltage inducing block 17 may be detachably connected to the first interface block 123, and may be configured to enable the second conversion block 122 to output a third direct current voltage via the first interface block 123 to supply power to a third external device.

The voltage inducing block 17 may be a block configured to induce a charger or a power supply device to output a higher voltage by simulating a demand of the device. After the voltage inducing block 17 is connected to the first interface block 123, the voltage inducing block 17 may induce the second conversion block 122 to output a voltage of a specific value, thereby supplying power to the third external device. That is, the third direct current voltage may be a second direct current voltage set to the specific value. The third external device may be a first external device requiring a specific power supply voltage. This configuration may enhance the power supply capability of the power supply system 1 for different external devices and improve the practicability of the power supply system 1.

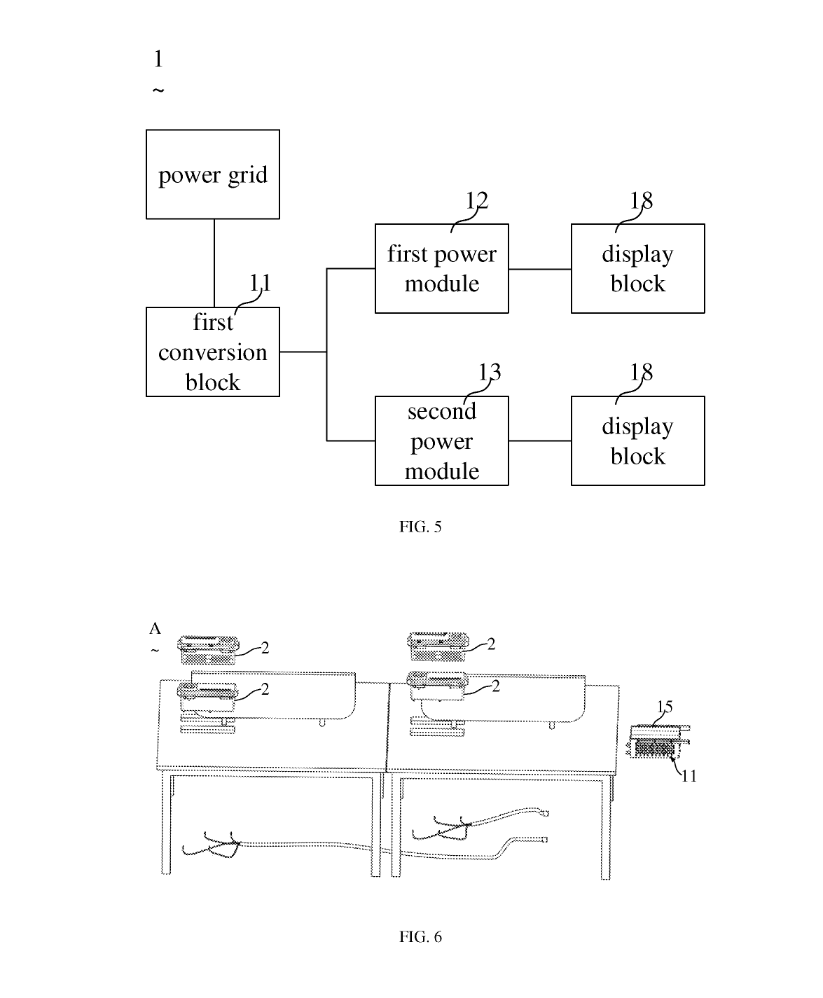

As shown in FIG. 5, FIG. 5 is a schematic structure view of a power supply system according to a fifth embodiment of the present disclosure. The power supply system 1 in the embodiments may further include a display block 18. The display block 18 may be connected to the first power module 12 and may be configured to display a real-time output parameter of the first power module 12. The display block 18 may also be connected to the second power module 13 and may be configured to display a real-time output parameter of the second power module 13.

The display block 18 may be connected to the second conversion block 122 and the third conversion block 132. The display block 18 may include a display screen configured to display real-time output voltages, real-time output currents, real-time output powers, etc. of output ports of the second conversion block 122 and the third conversion block 132, enabling the user to intuitively obtain the operating efficiency of the first power module 12 and the second power module 13.

The display block 18 may also display information of a connected first external device or a connected second external device. For example, in a case where a mobile phone is connected to the second conversion block 122 via a Type-C interface, and the second conversion block 122 outputs current to power the mobile phone, the display block 18 may also display a remaining battery level of the mobile phone, an estimated remaining charging time, etc., thereby improving the interaction capability of the power supply system 1 with the user, which is not limited in the present disclosure.

In some embodiments, the display block 18 may include an LED light. In a case where the second conversion block 122 and the third conversion block 132 are operating normally, the LED light may emit a green light. In a case where the second conversion block 122 or the third conversion block 132 is abnormal, a corresponding LED light may emit a red light to remind the user that the second conversion block 122 and/or the third conversion block 132 are abnormal and requires replacement.

In some embodiments, the display block 18 may also include other structures, which is not limited in the present disclosure.

In summary, in the power supply system 1 provided by the present disclosure, the first conversion block 11 may be arranged to convert the first alternating current voltage of the power grid (e.g., 96V to 264V) into the first direct current voltage for transmission. Subsequently, based on user requirements, the first power module 12 may be arranged to convert the first direct current voltage (e.g., 48V) into the second direct current voltage, and the second power module 13 may be arranged to convert the first direct current voltage into the second alternating current voltage. This configuration may lower the energy consumption of the power supply system 1 and ensure that all areas accessible to users may be supplied with low-voltage direct current, thereby enhancing the safety of the power supply system 1.

The first conversion block 11, the second conversion block 122, and the third conversion block 132 may all be detachable and replaceable blocks. In a case where any one of the first conversion block 11, the second conversion block 122, or the third conversion block 132 in the power supply system 1 is abnormal, the user may replace the first conversion block 11, the second conversion block 122, or the third conversion block 132, thereby reducing the maintenance difficulty of the power supply system 1 and improving the user experience with the power supply system 1.

The power supply system 1 provided by the present disclosure may be applied to an office area. The first power module 12 and the second power module 13 may be disposed at corresponding office workstations respectively. The office area may include a first office workstation, a second office workstation, and a third office workstation. In a case where the user at the first office workstation uses the first external device for work, only the first power module 12 may be disposed at the first office workstation. In a case where the user at the second office workstation uses the second external device for work, only the second power module 13 may be disposed at the second office workstation. In a case where the user at the third office workstation uses both the first external device and the second external device for work, both the first power module 12 and the second power module 13 may be disposed at the third office workstation.

The third office workstation may be disposed with two installation positions to install both the first power module 12 and the second power module 13. Both the first office workstation and the second office workstation may be disposed with two installation positions. One installation position at the first office workstation may be installed with the first power module 12, and the other installation position may be in an idle state. One installation position at the second office workstation may be installed with the second power module 13, and the other installation position may be in an idle state. In a case where the user at the first office workstation needs to operate the second external device, the second power module 13 may be installed in the idle installation position to supply power to the second external device. In a case where the user at the second office workstation needs to operate the first external device, the first power module 12 may be installed in the idle installation position to supply power to the first external device.

Alternatively, each of the two installation positions at the first office workstation may be installed with the first power module 12 to provide more power supply interfaces for the first external device. Each of the two installation positions at the second office workstation may be installed with the second power module 13 to provide more power supply interfaces for the second external device.

The first conversion block 11 may first convert the alternating current of the power grid into direct current for transmission, ensuring that all areas accessible to users may be supplied with low-voltage direct current, and thereby improving user safety during use. In addition, the second power module 13 may be disposed only at the office workstation where the user needs to operate the second external device, thereby reducing the number of high-voltage alternating current output ports in the office area and further improving user safety when using the power supply system 1.

Meanwhile, both the first power module 12 and the second power module 13 may be configured as detachable and replaceable modules disposed in the office area. This configuration may meet the power supply requirements of the user for different external devices, improve the practicability of the power supply system 1 in the office area, and enhance the user experience with the power supply system 1.

The present disclosure also provides an office integrated power supply device A. As shown in FIG. 6, FIG. 6 is a schematic structure view of an office integrated power supply device according to some embodiments of the present disclosure. The office integrated power supply device A provided by the embodiments of the present disclosure may include at least one office workstation and the power supply system 1 as described above. The first power module 12 and the second power module 13 of the power supply system 1 may be disposed at the corresponding office workstation, and may be configured to supply power to external devices located at the office workstation.

Only one first power module 12 may be disposed at each office workstation, and the second power module 13 may be disposed only at the office workstation with an external device requiring alternating current power supply, so as to reduce the number of alternating current output ports and improve user safety during use.

Alternatively, each office workstation may be equipped with both the first power module 12 and the second power module 13 to satisfy the power supply requirements of different external devices at the office workstation and improve the user experience with the office integrated power supply device A.

The office integrated power supply device A may further include at least one housing 2. Each of the at least one housing 2 may be defined with an accommodating cavity. Each housing may be disposed at a corresponding office workstation. The accommodating cavity may be configured to accommodate the first power module 12 and the second power module 13 respectively to isolate the first power module 12 and the second power module 13, thereby improving the aesthetics of the office workstation and further enhancing the user experience with the office integrated power supply device A.

The connection block 15 and the first conversion block 11 in the power supply system 1 may be disposed on a wall of the office area, and connected to the first power module 12 and the second power module 13 inside the housing 2 disposed at the office workstation through wires. In addition, a fixing plate may be provided on a desktop of the office workstation to fix the housing 2.

The above descriptions may only be embodiments of the present disclosure, and may not be intended to limit the patent scope of the present disclosure. Any equivalent structural or process transformations made by using the contents of the specification and drawings of the present disclosure, or directly or indirectly applied in other related technical fields, shall similarly be included within the patent protection scope of the present disclosure.

1. A power supply system, comprising:
a first conversion block, wherein a first end of the first conversion block is connected to a power grid, and the first conversion block is configured to convert a first alternating current voltage of the power grid into a first direct current voltage;
at least one first power module, connected to a second end of the first conversion block, wherein each of the at least one first power module is configured to convert the first direct current voltage into a second direct current voltage, and the second direct current voltage is configured to supply power to a first external device; and
at least one second power module, connected to the second end of the first conversion block, wherein each of the at least one second power module is configured to convert the first direct current voltage into a second alternating current voltage, and the second alternating current voltage is configured to supply power to a second external device.

2. The power supply system according to claim 1, wherein the first power module comprises a first protection block, a second conversion block, and a first interface block;
the second conversion block is detachably disposed between the first protection block and the first interface block;
a first end of the second conversion block is connected to the second end of the first conversion block via the first protection block, and a second end of the second conversion block is connected to the first interface block;
the second conversion block is configured to convert the first direct current voltage into the second direct current voltage;
the first interface block is connected to the first external device.

3. The power supply system according to claim 2, wherein the first protection block comprises a hot-swappable power supply protection block.

4. The power supply system according to claim 1, wherein the second power module comprises a second protection block, a third conversion block, and a second interface block;
the third conversion block is detachably disposed between the second protection block and the second interface block;
a first end of the third conversion block is connected to the second end of the first conversion block via the second protection block, and a second end of the third conversion block is connected to the second interface block;
the third conversion block is configured to convert the first direct current voltage into the second alternating current voltage;
the second interface block is connected to the second external device.

5. The power supply system according to claim 4, wherein the second interface block comprises at least one of a power strip and a socket.

6. The power supply system according to claim 4, wherein the second protection block comprises a hot-swappable power supply protection block.

7. The power supply system according to claim 1, further comprising a protection switch and a connection block; wherein
a first end of the protection switch is connected to the power grid, a second end of the protection switch is connected to a first end of the connection block, and a second end of the connection block is connected to the first power module and the second power module;
the first conversion block is detachably mounted on the connection block, and the first end of the connection block and the second end of the connection block are connected via the first conversion block.

8. The power supply system according to claim 2, further comprising a telescopic wire block, wherein the telescopic wire block is detachably connected to the first interface block, and the first interface block is configured to supply power to the first external device via the telescopic wire block.

9. The power supply system according to claim 2, wherein the first interface block comprises at least one of a Type-C interface, a USB-A interface, an HDMI interface, a network interface, and a direct current interface.

10. The power supply system according to claim 2, further comprising a voltage inducing block, wherein the voltage inducing block is detachably connected to the first interface block and configured to enable the second conversion block to output a third direct current voltage via the first interface block to supply power to a third external device.

11. The power supply system according to claim 1, further comprising a display block, wherein the display block is connected to the first power module and configured to display a real-time output parameter of the first power module, and the display block is connected to the second power module and configured to display a real-time output parameter of the second power module.

12. The power supply system according to claim 1, wherein a voltage value of the first direct current voltage is different from a voltage value of the second direct current voltage.

13. An office integrated power supply device, comprising:
at least one office workstation; and
a power supply system, comprising:
a first conversion block, wherein a first end of the first conversion block is connected to a power grid, and the first conversion block is configured to convert a first alternating current voltage of the power grid into a first direct current voltage;
at least one first power module, connected to a second end of the first conversion block, wherein each of the at least one first power module is configured to convert the first direct current voltage into a second direct current voltage, and the second direct current voltage is configured to supply power to a first external device; and
at least one second power module, connected to the second end of the first conversion block, wherein each of the at least one second power module is configured to convert the first direct current voltage into a second alternating current voltage, and the second alternating current voltage is configured to supply power to a second external device;
wherein the first power module and the second power module of the power supply system are disposed at a corresponding one of the at least one office workstation and configured to supply power to external devices located at the corresponding one of the at least one office workstation.

14. The office integrated power supply device according to claim 13, further comprising at least one housing, wherein each of the at least one housing is defined with an accommodating cavity and is disposed at a corresponding one of the at least one office workstation, and the accommodating cavity is configured to accommodate the first power module and the second power module.

15. The office integrated power supply device according to claim 13, wherein the first power module comprises a first protection block, a second conversion block, and a first interface block;
the second conversion block is detachably disposed between the first protection block and the first interface block;
a first end of the second conversion block is connected to the second end of the first conversion block via the first protection block, and a second end of the second conversion block is connected to the first interface block;
the second conversion block is configured to convert the first direct current voltage into the second direct current voltage;
the first interface block is connected to the first external device.

16. The office integrated power supply device according to claim 13,
wherein the second power module comprises a second protection block, a third conversion block, and a second interface block;
the third conversion block is detachably disposed between the second protection block and the second interface block;
a first end of the third conversion block is connected to the second end of the first conversion block via the second protection block, and a second end of the third conversion block is connected to the second interface block;
the third conversion block is configured to convert the first direct current voltage into the second alternating current voltage;
the second interface block is connected to the second external device.

17. The office integrated power supply device according to claim 13, wherein the power supply system further comprises a protection switch and a connection block;
a first end of the protection switch is connected to the power grid, a second end of the protection switch is connected to a first end of the connection block, and a second end of the connection block is connected to the first power module and the second power module;
the first conversion block is detachably mounted on the connection block, and the first end of the connection block and the second end of the connection block are connected via the first conversion block.

18. The office integrated power supply device according to claim 15, wherein the power supply system further comprises a telescopic wire block, the telescopic wire block is detachably connected to the first interface block, and the first interface block is configured to supply power to the first external device via the telescopic wire block.

19. The office integrated power supply device according to claim 15, wherein the power supply system further comprises a voltage inducing block, and the voltage inducing block is detachably connected to the first interface block and configured to enable the second conversion block to output a third direct current voltage via the first interface block to supply power to a third external device.

20. The office integrated power supply device according to claim 13, wherein the power supply system further comprises a display block, the display block is connected to the first power module and configured to display a real-time output parameter of the first power module, and the display block is connected to the second power module and configured to display a real-time output parameter of the second power module.
